(19) United States
(12) Patent Application Publication
(10) Pub. No.: US 2004/0217125 A1
(43) Pub. Date: Nov. 4, 2004

(54) Device for dispensing a liquid washing or rinsing agent, particularly for a dishwasher

(75) Inventor: Giuseppe Marone, Moncalieri (Torino) (IT)

Correspondence Address: SUGHRUE MION, PLLC, 2100 PENNSYLVANIA AVENUE, N.W., SUITE 800, WASHINGTON, DC, 20037, US

(73) Assignee: ELBI INTERNATIONAL S.P.A.

(21) Appl. No.: 10/770,572

(22) Filed: Feb. 4, 2004

(30) Foreign Application Priority Data
Feb. 5, 2003 (IT) TO2003A000073

(51) Int. Cl. B67D 5/08

(52) U.S. Cl. 222/64

(57) ABSTRACT

The device comprises a shaped body to be fixed to the door of a dishwasher. The body comprises two half-shells of moulded plastics material, that is, a front half-shell and a rear half-shell, respectively, which are shaped in a manner such as to define between them at least one region or chamber suitable for housing a quantity of a liquid washing or rinsing agent. The front half-shell is opaque and has, in a wall of the chamber, a level-indicating aperture or window which is closed by an at least partially transparent element and which, in use, when the door of the machine is open, provides a visual indication of the quantity of agent contained in the chamber. The at least partially transparent element is formed by a wall moulding formed integrally with the rear half-shell and welded in a liquid-tight manner to the wall of the front half-shell in the vicinity of the said opening or window.

The present invention relates to a device for dispensing a liquid washing or rinsing agent for a washing machine, such as in particular a dishwasher, provided with a front door which is movable between a substantially vertical, closure position and an inclined, preferably at least approximately horizontal, open position.

More specifically, the subject of the invention is a dispensing device of the type comprising a shaped body to be fixed to or in the face of the door which faces the interior of the machine, and comprising two half-shells of moulded plastics material, that is, a front half-shell and a rear half-shell, respectively, which are coupled with one another and are shaped in a manner such as to define between them at least one chamber suitable for housing a quantity of the agent, and in which the front half-shell is opaque and has, in a wall of the chamber, a level-indicating aperture or window which is closed by an at least partially transparent element and which, in use, when the door of the machine is open, can provide a user with a visual indication of the quantity of washing or rinsing agent contained in the chamber.

In dispensers of this type which have been produced up to now, the at least partially transparent element associated with the level-indicating window is formed as an independent element and is mounted in a suitable seat in the vicinity of the edge of the level-indicating aperture or window with the use of an associated sealing ring.

The object of the present invention is to provide a dispensing device of the above-mentioned type which comprises a smaller number of parts and can be assembled relatively easily and with a reduced number of steps.

This and other objects are achieved, according to the invention, by a dispensing device of the type specified above, characterized in that the at least partially transparent element is formed by a wall moulding formed integrally with the rear half-shell and heat-sealed in a liquid-tight manner to the wall of the front half-shell, in the vicinity of the level-indicating aperture or window.

Further characteristics and advantages of the invention will become clear from the following detailed description which is given purely by way of non-limiting example with reference to the appended drawings, in which:

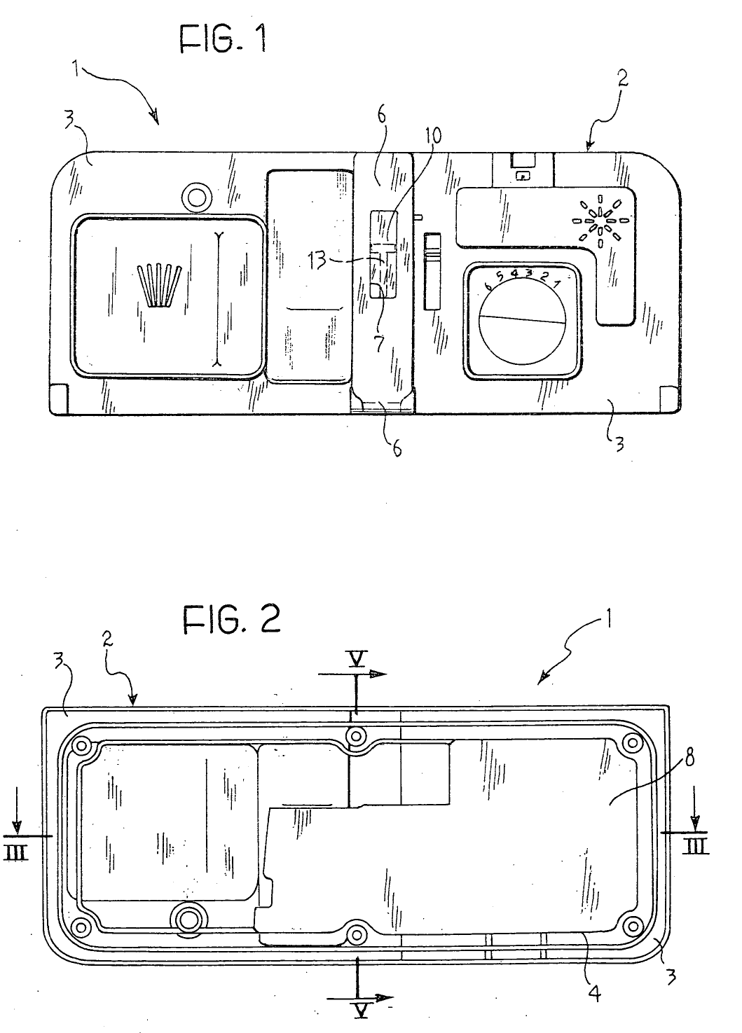

FIG. 1 is a front view of a dispensing device according to the invention,

FIG. 2 is a rear view of the device of FIG. 1,

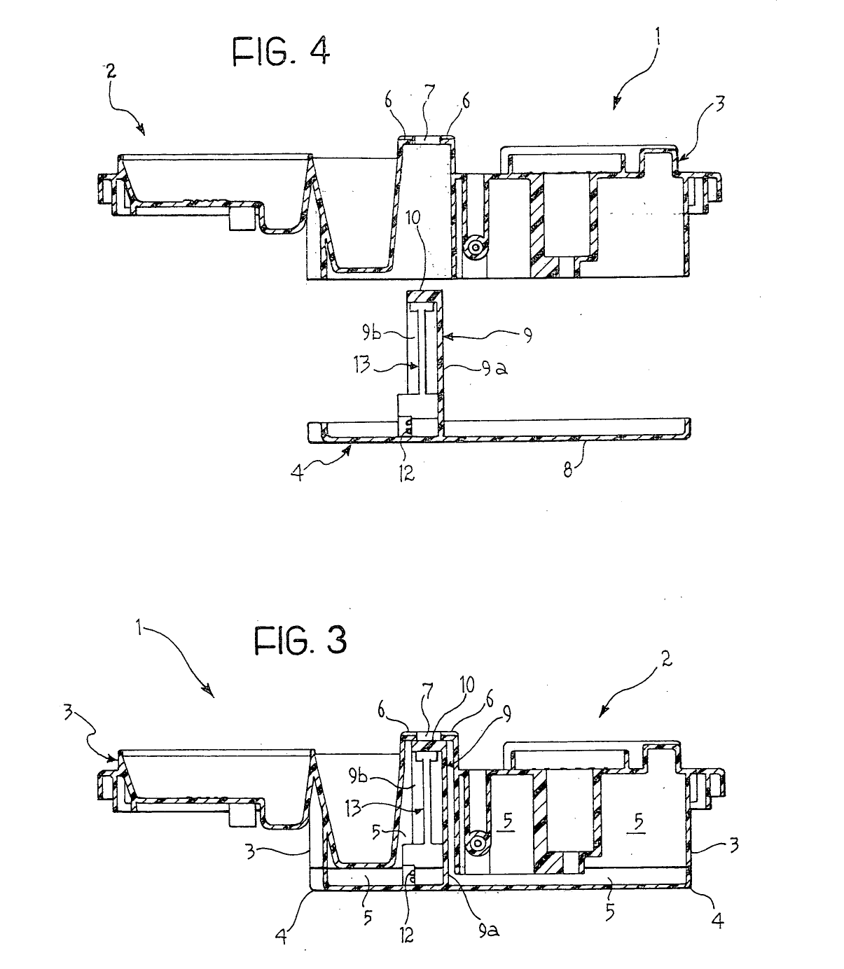

FIG. 3 is a view sectioned on the line III-III of FIG. 2,

FIG. 4 is a sectioned view similar to that shown in FIG. 3 and shows the two, front and rear, half-shells of the body of the dispensing device, prior to their mutual coupling,

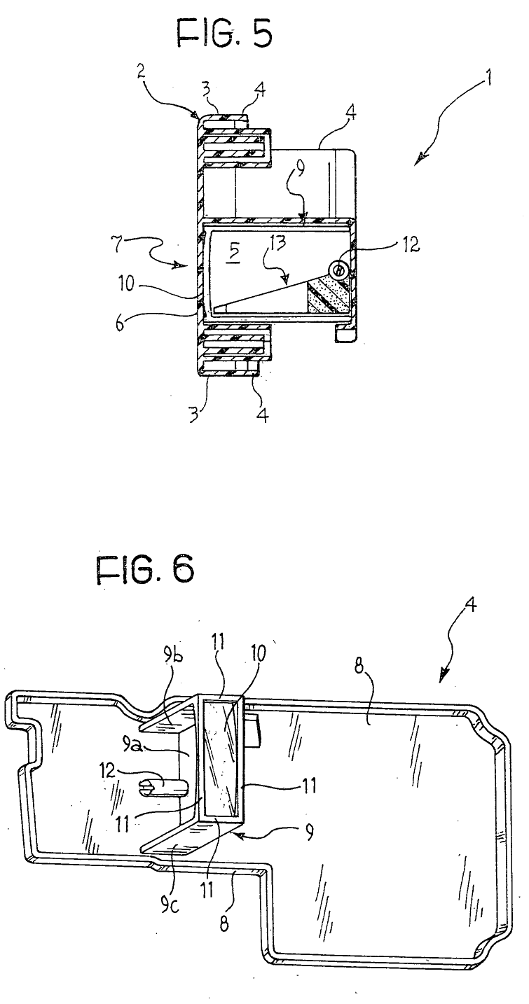

FIG. 5 is a view sectioned on the line V-V of FIG. 2,

FIG. 6 is a perspective view of the rear half-shell of the body of the dispensing device according to the preceding drawings,

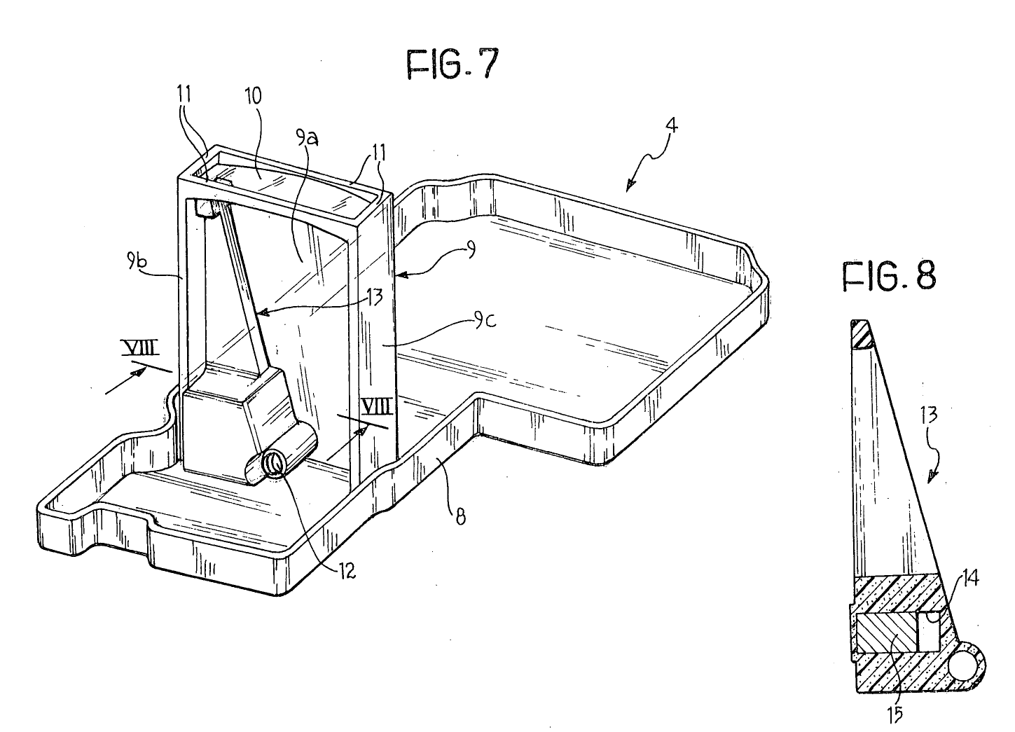

FIG. 7 is another perspective view of the rear half-shell of the dispensing device and also shows a floating indicator element connected to that half-shell, and

FIG. 8 is a view of the floating indicator element, sectioned substantially along the line VIII-VIII of FIG. 7.

A device for dispensing a washing or rinsing agent for a dishwasher is generally indicated 1 in FIGS. 1 to 5.

As can best be seen in FIGS. 2 to 5, the dispensing device 1 comprises a shaped body 2 formed by two half-shells 3 and 4, that is, a front half-shell and a rear half-shell, respectively, of moulded plastics material, coupled with one another, for example, by heat-sealing by devices known per se, for example, of the hot blade type.

The body 2 of the dispensing device is intended to be fixed to or in the inner face of the dishwasher door so that, in the mounted condition, only the front half-shell 3 is visible, as is apparent in FIG. 1.

The half-shells 3 and 4 can advantageously be produced by injection moulding of a plastics material such as polypropylene. The front half-shell 3 is in any case produced conventionally from an opaque plastics material, whereas the rear half-shell 4 is advantageously produced integrally from an at least partially transparent plastics material such as non-filled polypropylene.

With reference to FIGS. 3 to 5, the half-shells 3 and 4 of the body 2 of the dispensing device are shaped so as to define between them at least one region or chamber 5 suitable for housing a quantity of a liquid washing or rinsing agent such as a so-called rinse-aid.

The methods and the means for loading the agent into the chamber 5 and for subsequently dispensing it are known and will not therefore be described.

In a wall of a portion of the region or chamber 5, the front half-shell 3 has a level-indicating aperture or window 7 (FIGS. 1 and 3-5).

As can best be appreciated from an observation of FIGS. 4, 6 and 7, the rear half-shell 4 of the body of the dispensing device comprises basically a rear cover 8 substantially in the form of a shallow dish which is roughly L-shaped in plan.

A wall moulding 9 with a channel-like cross-section with a main wall 9a and two facing side walls or sides 9b and 9c extends perpendicularly from the base wall of the cover 8 (see FIGS. 6 and 7 in particular).

A plate-like element 10, substantially parallel to the base wall of the cover 8, is connected to the upper end of the wall moulding 9.

The cover 8, the wall moulding 9 and the upper plate-like element 10 are formed integrally as a single piece of moulded plastics material.

Preferably, the plate-like element 10 is formed so as to be slightly recessed relative to a peripheral top edge indicated 11 in FIGS. 6 and 7. When the rear half-shell 4 is coupled with the front half-shell 3 (FIG. 3), the edge 11 is arranged in the region of and, for example, is heat sealed to, the edge of the aperture or window 7 of the front half-shell 3 (FIG. 3).

The wall moulding 9 extends inside the region 5 in which the liquid washing or rinsing agent is contained, so as to be spaced from the peripheral walls of that region or chamber, permitting easy fluid communication between the portions of that region or chamber that situated on either side of the wall moulding.

With reference to FIGS. 6 and 7, a fixed pin-like moulding 12, integral with the rear half-shell, extends from a face of the wall 9a thereof.

A floating indicator element, generally indicated 13, is mounted rotatably on the pin 12. The floating element is made, for example, of expanded polypropylene and may have a cavity 14 (FIG. 8) which can house a permanent magnet 15, the functions of which will be defined below.

During assembly, the two half-shells 3 and 4 of the body 2 of the dispensing device are coupled with one another and, for example, are heat-sealed, as shown in the series of FIGS. 3 and 4. The heat-sealing is performed at least at two levels, that is, at the level of the peripheral edge 11 and at the level of the edge of the side wall of the lower cover 8, by techniques known per se. Naturally, the coupling and the heat-sealing take place with the floating indicator element 13 pre-fitted on the pin-like moulding 12 of the rear half-shell 4.

The dispensing device 1 is then fixed to or in the inner face of the machine door in known manner.

When the machine door is in the approximately horizontal, open arrangement, the user can see the floating indicator element 13 through the at least partially transparent element 10, as is clear from FIG. 1. In this condition, the angular position of the distal end of the floating indicator element 13 relative to the axis of the pin 12 depends on the quantity of the liquid agent which is contained in the region or chamber 5; in fact, the force exerted on the floating indicator element 13, and hence the moment which that force exerts on the floating indicator 13 with respect to the axis of the pin 12, varies according to the quantity of liquid in that region or chamber.

When, with the door open, the level of washing or rinsing liquid contained in the region or chamber 5 reaches a predetermined minimum value, the floating indicator element 13 is arranged in a position such that its permanent magnet 15 can bring about switching of an associated indicator device (not shown) such as a reed relay or the like.

Naturally, the principle of the invention remaining the same, the forms of embodiment and the details of construction may be varied widely with respect to those described and illustrated purely by way of non-limiting example, without thereby departing from the scope of the invention as defined in the appended claims.

What is claimed is:

1. A device for dispensing a liquid washing or rinsing agent for a washing machine, such as a dishwasher, provided with a front door which is movable between a substantially vertical, closure position and an inclined, preferably at least approximately horizontal, open position,
the dispensing device comprising a shaped body to be fixed to or in the face of the door which faces the interior of the machine, the body comprising two half-shells of moulded plastics material, that is, a front half-shell and a rear half-shell, respectively, which are coupled with one another and are shaped in a manner such as to define between them at least one region or chamber suitable for housing a quantity of the agent, and in which the front half-shell is opaque and has, in a wall of the chamber, a level-indicating aperture or window which is closed by an at least partially transparent element and which, in use, when the door of the machine is open, can provide a user with a visual indication of the quantity of agent contained in the chamber,
the at least partially transparent element being formed by a wall moulding formed integrally with the rear half-shell and welded in a liquid-tight manner to the wall of the front half-shell in the vicinity of the said aperture or window.

2. A device according to claim 1 in which the rear half-shell is formed integrally from an at least partially transparent, moulded plastics material.

3. A device according to claim 1, in which a floating indicator element is arranged in a portion of the region or chamber facing the window and is visible through the window when the door is open.

4. A device according to claim 3, in which the floating indicator element is connected to the body so as to be rotatable about a substantially horizontal axis.

5. A device according to claim 4 in which the floating indicator element is mounted so as to be rotatable relative to a fixed pin formed in a single piece with the rear half-shell, and is arranged facing the at least partially transparent element.

6. A device according to claim 3 in which the floating indicator element carries a permanent magnet which can bring about switching of an associated indicator device when the washing or rinsing agent in the region or chamber reaches a predetermined level, with the door open.
